(19) United States
(12) Patent Application Publication
(10) Pub. No.: US 2009/0284604 A1
(43) Pub. Date: Nov. 19, 2009

(54) Method and a device for adjusting a color temperature coordinate value measured by a display color analyzer

(75) Inventors: Tsang-Hsing Lee, Taipei Hsien (TW); Fang-Wen Liao, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/292,413

(22) Filed: Nov. 19, 2008

(30) Foreign Application Priority Data
May 13, 2008 (TW) 097117553

(51) Int. Cl. H04N 17/02

(52) U.S. Cl. 348/181; 348/E17.004

(57) ABSTRACT

A method and a device for adjusting a color temperature coordinate value which is measured by a display color analyzer are disclosed. The device comprises a main control module. The method comprises the following steps: displaying a test image on a standard monitor; receiving a color temperature coordinate value of the standard monitor which is measured by the display color analyzer; obtaining a default standard color temperature coordinate value and comparing with the measured color temperature coordinate value to obtain a color temperature offset value; and adjusting the color temperature coordinate value measured by the display color analyzer by using the color temperature offset value.

### BACKGROUND OF THE INVENTION

1. Field of the Invention

The present invention relates to an adjusting method and a device for a display color analyzer, and more particularly, to a method and a device for adjusting a color temperature coordinate value measured by a display color analyzer.

2. Description of the Related Art

As technologies evolve and people's living quality improve, now people demand monitors to provide more than merely displaying functions and to stress on the performance of color signals rendering. Therefore, the precision of the display color analyzer is important in adjusting monitors. In other words, the monitor adjustment of display color analyzer is a crucial step in the monitor manufacturing process presently.

Usually, in prior art manufacturing process, it is using different channels of the display color analyzer to obtain different color temperatures of a standard monitor and comparing the measured color temperatures with default color temperatures to obtain an offset value to adjust the display color analyzer. However, a large number of channels of the display color analyzer required to be adjusted during the adjusting process could lead to time-consuming work. On the other hand, in prior art white balance adjusting process, it is usually required to obtain two different brightness levels on two different channels to avoid inaccuracy in measuring brightness levels on one single channel. However, it costs a lot of effort to verify additional channels on the display color analyzer and also increases the cost and load of the manufacturing line.

Therefore, it is advantageous to provide a new method and a new device for adjusting the display color analyzer to solve the problems encountered by the prior art techniques.

### SUMMARY OF THE INVENTION

It is an object of the present invention to provide a device for adjusting a color temperature coordinate value measured by a display color analyzer so as to adjust the color temperature coordinate value measured by the display color analyzer.

It is another object of the present invention to provide a method for adjusting a color temperature coordinate value measured by a display color analyzer.

In order to achieve the above objects, the device for adjusting a color temperature coordinate value measured by a display color analyzer comprises a main control module for receiving a color temperature coordinate value of a standard monitor displaying a test image which is measured by the display color analyzer, comparing the color temperature coordinate value with a default standard color temperature coordinate value to obtain a color temperature offset value, and adjusting the color temperature coordinate value measured by the display color analyzer by using the color temperature offset value.

The method for adjusting a color temperature coordinate value measured by a display color analyzer comprises the following steps: displaying a test image on a standard monitor; receiving a color temperature coordinate value of the standard monitor which is measured by the display color analyzer; obtaining a default standard color temperature coordinate value and comparing with the measured color temperature coordinate value to obtain a color temperature offset value; and adjusting the color temperature coordinate value measured by the display color analyzer by using the color temperature offset value.

### BRIEF DESCRIPTION OF THE DRAWINGS

FIG. 1 illustrates a structural view of the color temperature coordinate value measured by the display color analyzer in the present invention;

FIG. 2 illustrates the flow chart of the method for adjusting the color temperature coordinate value measured by the display color analyzer in the present invention;

FIG. 3 illustrates the flow chart of using the color temperature coordinate value measured by the display color analyzer to adjust the test monitor.

### DETAILED DESCRIPTION OF THE PREFERRED EMBODIMENT

The advantages and innovative features of the invention will become more apparent from the following detailed description when taken in conjunction with the accompanying drawings.

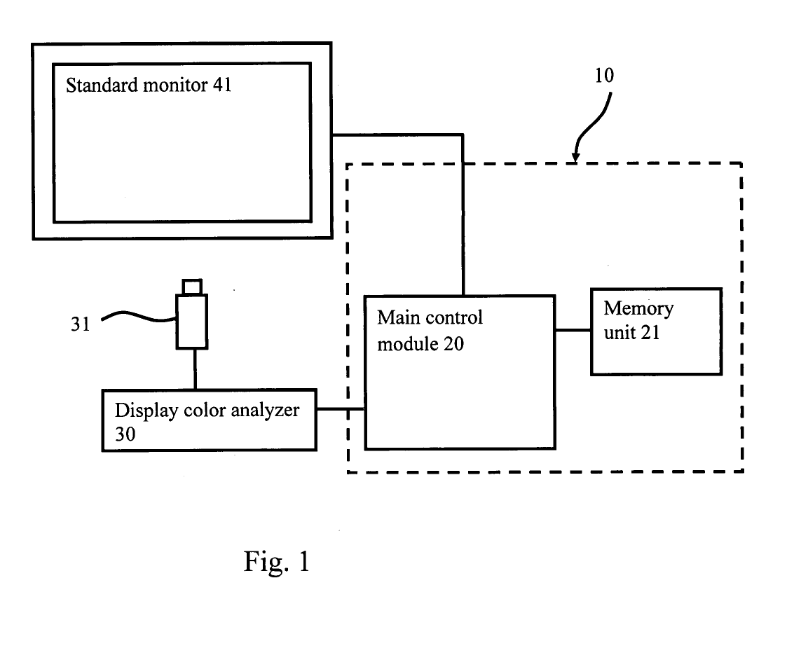

Please refer to FIG. 1, which illustrates a structural view of the color temperature coordinate value measured by the display color analyzer in the present invention.

The present invention discloses an adjusting device 10 for adjusting a color temperature coordinate value measured by a display color analyzer 30 so as to let the color temperature coordinate value meet different requiring standards and to let the display color analyzer 30 do adjustment according to the offset value obtained from the measured result and the requiring standard.

The adjusting device 10 for adjusting a color temperature coordinate value measured by the display color analyzer comprises a main control module 20 and a memory unit 21. The main control module 20 is electrically coupled to the memory unit 21 and the display color analyzer 30. The main control module 20 can be a host computer; however, it is not intended to limit the present invention. The memory unit 21 is used for recording the value which the main control module 20 uses to adjust the display color analyzer 30.

The display color analyzer 30 comprises an image capturing module 31 for capturing the color temperature value of a standard monitor 41 for further analysis so as to obtain the related color temperature coordinate value. The main control module 20 compares the color temperature coordinate value provided by the display color analyzer 30 with a default standard color temperature coordinate value to obtain a color temperature offset value. When the display color analyzer 30 is to perform analysis to other test monitors which need adjustments, it reads the color temperature offset value directly from the memory unit 21 to adjust the test monitors. The method for adjusting a color temperature coordinate value measured by the display color analyzer 30 will be described later. On the other hand, the main control module 20 can control a plurality of display color analyzer 30 simultaneously to adjust different test monitors. Since different display color analyzers 30 have different serial numbers, therefore, the main control module 20 records a serial number and its corresponding color temperature offset value of each one of the display color analyzers 30 in the memory unit 21. When the main control module is to adjust the test monitor, it reads the serial number and its color temperature offset value for adjustment.

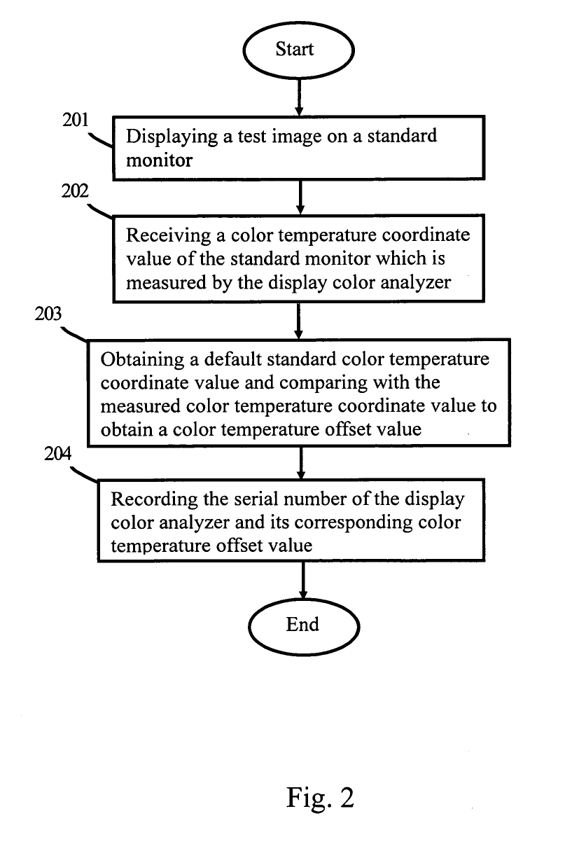

Now please refer to FIG.2, which illustrates the flow chart of the method for adjusting the color temperature coordinate value measured by the display color analyzer in the present invention. It is noted that although the method for adjusting the color temperature coordinate value measured by the display color analyzer is described with the device 10 for adjusting a color temperature coordinate value measured by the display color analyzer, the method for adjusting the color temperature coordinate value measured by the display color analyzer is not limited to use with the device 10 for adjusting a color temperature coordinate value measured by the display color analyzer.

First the method starts at step 201: displaying a test image on a standard monitor.

The standard monitor 41 shows the test image, which is controlled by the main control module 20; however, the present invention can use different devices to control the test image.

Then the method proceeds to step 202: receiving a color temperature coordinate value of the standard monitor which is measured by the display color analyzer.

Now the display color analyzer 30 measures the color temperature of the standard monitor 41 and lets the main control module 20 receive the color temperature coordinate value. In a preferred embodiment of the present invention, the display color analyzer 30 is adjusted to its initial channel and then to measure the color temperature of the standard monitor 41, wherein the initial channel of the display color analyzer 30 is the original measuring channel of the display color analyzer 30 which has fixed setup parameters and can not be changed by a user. Therefore it is possible to use the initial channel of the display color analyzer 30 to measure different color temperatures of the standard monitor 41 to obtain a plurality of color temperature coordinate values.

Step 203: obtaining a default standard color temperature coordinate value and comparing with the measured color temperature coordinate value to obtain a color temperature offset value.

When the color temperature coordinate value is obtained, the main control module 20 compares the measured color temperature coordinate value with the default standard color temperature coordinate value to obtain the color temperature offset value, wherein the default standard color temperature coordinate value is the correct color temperature coordinate value of the standard monitor 41. Therefore, comparing the measured color temperature coordinate value with the default standard color temperature coordinate value can tell the difference between the default standard color temperature coordinate value and the color temperature coordinate value measured by the display color analyzer 30 so as to adjust the color temperature coordinate value measured by the display color analyzer 30 based on the color temperature offset value.

Finally the method proceeds to step 204: recording the serial number of the display color analyzer and its corresponding color temperature offset value.

Since each one of the display color analyzers 30 has its own serial number, therefore the main control module 20 stores both the serial number of the display color analyzer and its corresponding color temperature offset value it read in the memory unit. Therefore it is possible to know the color temperature offset value corresponding to each one of the display color analyzers 30. It is noted that the step of reading the serial number of the display color analyzer 30 can be executed at step 202 or step 204, and it is not limited to any specific step.

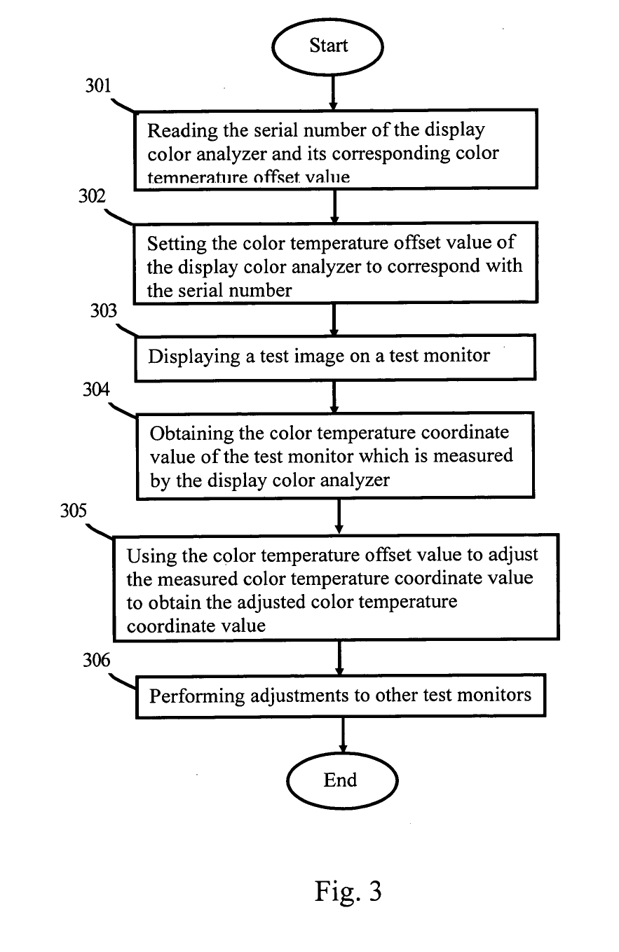

The above steps complete the adjusting process of the display color analyzer 30. Now please refer to FIG. 3, which illustrates the flow chart of using the color temperature coordinate value measured by the display color analyzer to adjust the test monitor.

First the present invention starts at step 301: reading the serial number of the display color analyzer and its corresponding color temperature offset value.

When performing adjustment to test monitors on a manufacturing line, the main control module 20 reads the serial number of the display color analyzer 30 on the manufacturing line and also the color temperature offset value corresponding to the serial number from the memory unit 21.

Then in step 302: setting the color temperature offset value of the display color analyzer to correspond with the serial number.

Because the color temperature offset value used to adjust the color temperature coordinate value measured by display color analyzer 30 is known, therefore the main control module 20 can set the color temperature offset value of the display color analyzer 30 according to the serial number, that is, the main control module 20 directly sets how much adjustment it is to perform to the color temperature coordinate value measured by the display color analyzer. When the display color analyzer 30 starts to measure a color temperature coordinate value of a test monitor, the main control module 20 can use the serial number of the test monitor to determine the correct color temperature coordinate value.

Then the process proceeds to step 303: displaying a test image on a test monitor.

Now the test monitor shows the test image, which is identical to the image described in step 201.

Then the process proceeds to step 304: obtaining the color temperature coordinate value of the test monitor which is measured by the display color analyzer.

Now the display color analyzer 30 measures the color temperature of the test monitor and lets the main control module 20 receive the measured color temperature coordinate value. This step will not be further described since it is similar to step 202.

Then in step 305: using the color temperature offset value to adjust the measured color temperature coordinate value to obtain the adjusted color temperature coordinate value.

Since the color temperature offset value of the display color analyzer 30 is recorded in step 204, therefore now the main control module 20 can read the color temperature offset value corresponding to the display color analyzer 30 from the memory unit 21. Then it further adjusts the color temperature coordinate value measured by the display color analyzer 30 to obtain the adjusted color temperature coordinate value.

Finally the process proceeds to step 306: performing adjustments to other test monitors.

Then the main control module 20 uses the adjusted color temperature coordinate value to adjust white balance and other parameters of the test monitors. It will not be further described since the adjustment methods performed towards monitors are known in the art.

It is noted that the method for adjusting the color temperature coordinate value measured by the display color analyzer is not limited to the order of steps described above; the order of the steps can be varied as long as it can fulfill the object of the present invention.

By using the above adjusting method, it is viable to adjust the color temperature coordinate value of the display color analyzer 30 to be as precise as possible so as to facilitate the adjusting process of monitors.

It is noted that the above-mentioned embodiments are only for illustration, it is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A device for adjusting a color temperature coordinate value measured by a display color analyzer, the device comprising:
a main control module for receiving a color temperature coordinate value of a standard monitor displaying a test image which is measured by the display color analyzer, comparing the color temperature coordinate value with a default standard color temperature coordinate value to obtain a color temperature offset value, and adjusting the color temperature coordinate value measured by the display color analyzer by using the color temperature offset value.

2. The device for adjusting a color temperature coordinate value measured by the display color analyzer as claimed in claim 1, wherein the main control module is a host computer.

3. The device for adjusting a color temperature coordinate value measured by the display color analyzer as claimed in claim 2 further comprising a memory unit for recording serial numbers of different display color analyzers and the corresponding color temperature offset values.

4. A method for adjusting a color temperature coordinate value measured by a display color analyzer, wherein the method is used by a device for adjusting a color temperature coordinate value measured by a display color analyzer to adjust the display color analyzer, the method comprising the following steps:
displaying a test image on a standard monitor;
receiving a color temperature coordinate value of the standard monitor which is measured by the display color analyzer;
obtaining a default standard color temperature coordinate value and comparing with the measured color temperature coordinate value to obtain a color temperature offset value; and
adjusting the color temperature coordinate value measured by the display color analyzer by using the color temperature offset value.

5. The method for adjusting a color temperature coordinate value measured by the display color analyzer as claimed in claim 4, wherein the step of adjusting the color temperature coordinate value measured by the display color analyzer by using the color temperature offset value further comprises:
displaying the test image on a test monitor;
obtaining a color temperature coordinate value of the test monitor measured by the display color analyzer; and
adjusting the color temperature coordinate value by using the color temperature offset value to obtain an adjusted color temperature coordinate value.

6. The method for adjusting a color temperature coordinate value measured by the display color analyzer as claimed in claim 4, wherein the step of adjusting the color temperature coordinate value measured by the display color analyzer by using the color temperature offset value further comprises:
reading a serial number of the display color analyzer; and
setting the color temperature offset value of the display color analyzer to correspond with the serial number.
